(19) United States
(12) Patent Application Publication
(10) Pub. No.: US 2015/0145677 A1
(43) Pub. Date: May 28, 2015

(54) COMPUTER-IMPLEMENTED SYSTEMS AND METHODS FOR MOLD PREVENTION

(71) Applicant: GERALD J. SMITH, JR., West Caldwell, NJ (US)

(72) Inventor: GERALD J. SMITH, JR., West Caldwell, NJ (US)

(21) Appl. No.: 14/088,043

(22) Filed: Nov. 22, 2013

(51) Int. Cl. G08B 21/18

(52) U.S. Cl. CPC G08B 21/182
USPC 340/540

(57) ABSTRACT

A computer-implemented method and system for mold prevention is provided. In one embodiment, a computer-implemented method for computer-implemented systems and methods for mold prevention may include at a server having one or more processors and memory storing one or more programs for execution by the one or more processors: receiving mold prevention data from a monitor disposed in a first location; analyzing the mold prevention data and determining if the mold prevention data conforms to an acceptable range of values; generating an alert if the mold prevention data does not conform to the acceptable range of values; and storing the mold prevention data in a database.

### BACKGROUND

1. Field of the Invention

Embodiments of the present invention are generally related to computer-implemented systems and methods for mold prevention. More specifically, embodiments of the present invention relate to computer-implemented systems and methods for capturing and/or analyzing data relating to temperature and humidity in a location, providing a detailed, easy to access, electronic risk assessment for the risk of mold formation, and providing an alert when conditions meet one or more predetermined thresholds.

2. Description of the Related Art

Mold is a well-known fungus that grows in the presence of moisture. Mold growth in buildings can lead to a number of health-related problems, including allergic reactions and respiratory problems. Some studies have indicated that high levels of mold and prolonged exposure to mold in a building can lead to neurological issues. Mold can typically found in areas of a building that are damp and dark, such as behind walls or underneath floor coverings, or the like.

Various practices have been implemented to mitigate and/or substantially remove mold from buildings. Current practices of handling mold problems within structures include containment, demolition, and replacement of building materials. This model is not environmentally friendly, as landfills continue to receive a substantial amount of mold-affected building materials. Mold problems are handled based on reactive model in a predominantly unregulated industry. Often, by the time mold is detected in a building, it has affected a substantial area, impacting indoor air quality and requiring costly and environmentally harmful procedures for remediation. Current methods of mold remediation are only implemented after the detection of mold fungi at a stage when mold has already formed in substantial amounts.

Thus, a need exists for a system and a method that may significantly reduce the costs and environmental hazards caused by current practices of mold remediation by detecting conditions that may cause the growth of mold before an extensive mold problem occurs.

### SUMMARY

Embodiments of the present disclosure relate to computer-implemented systems and methods for mold prevention. In one embodiment, a computer-implemented method for mold prevention may comprise, at a server having one or more processors and memory storing one or more programs for execution by the one or more processors, receiving and capturing conducive condition data for mold fungi formation and mold prevention data from a monitor disposed in a first location; analyzing the mold prevention data and determining if the mold prevention data conforms to an acceptable range of values; generating an alert if the mold prevention data does not conform to the acceptable range of values; and storing the mold prevention data in a database.

In another embodiment of the present disclosure, a computer-implemented method for mold prevention may comprise, at a client having one or more processors and memory storing one or more programs for execution by the one or more processors, receiving mold prevention data from a monitor disposed in a first location; analyzing the mold prevention data and determining if the mold prevention data conforms to an acceptable range of values; generating an alert if the mold prevention data does not conform to the acceptable range of values; storing the mold prevention data in a database; receiving a second set of mold prevention data from a second monitor disposed in a second location; analyzing the second set of mold prevention data and determining if the second set of mold prevention data conforms to the acceptable range of values; generating an second alert if the second set of mold prevention data does not conform to the acceptable range of values; and storing the second set of mold prevention data in a database.

In yet another embodiment of the present disclosure, a system is provided that may comprise at least one server, the server comprising one or more processors; and memory; wherein the at least one server is configured to receive mold prevention data from a monitor disposed in a first location; analyze the mold prevention data and determining if the mold prevention data conforms to an acceptable range of values; generate an alert if the mold prevention data does not conform to the acceptable range of values; and store the mold prevention data in a database.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of an electronic pre-mold and mold prevention system in accordance with embodiments of the present invention;

FIG. 2 depicts a block diagram of a general computer system, which is capable of being used in connection with the system depicted in FIG. 1, in accordance with embodiments of the present invention;

FIG. 3 depicts a top view of a location and a monitoring unit in accordance with embodiments of the present invention;

FIG. 4 depicts a block diagram of a monitoring unit in accordance with embodiments of the present invention;

FIG. 5 depicts a block diagram of an electronic mold prevention system in accordance with embodiments of the present disclosure;

FIG. 6 depicts a block diagram of a side view of an exemplary building in accordance with embodiments of the present invention;

FIG. 7 depicts an exemplary client computer capable of being used with the system depicted in FIG. 1, in accordance with embodiments of the present invention; and

FIG. 8 depicts a flow diagram illustrating an exemplary method for electronic mold prevention in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to computer-implemented systems and methods for mold prevention. More specifically, embodiments of the present invention relate to computer-implemented systems and methods for capturing and/or analyzing data relating to temperature and humidity in a location, providing a detailed, easy to access, electronic risk assessment for the risk of mold formation, and providing an alert or series of alerts when conditions meet one or more predetermined thresholds. A spike in data capture which approaches “breach” of an acceptable range of values may trigger an initial cautionary alert prior to arrival of the non-conforming acceptable range of values which are conducive to mold formation. In some embodiments, a breach of an acceptable range of values may comprise a temperature increase and/or decrease at a rate higher than a predetermined rate and/or during a predetermined time. For example, if the rate of temperature and/or relative humidity in a property increase at a substantially higher rate, for example greater than 10%, than a neighboring room, property, outdoor area, or the like, then the system may identify this as a breach. In some embodiments, a breach may occur when the temperature and/or humidity surpass a maximum value in an acceptable range of values. In some embodiments, the range of acceptable values may be adjusted by an administrator or automatically adjusted by receiving updates from a third party server, and/or the like.

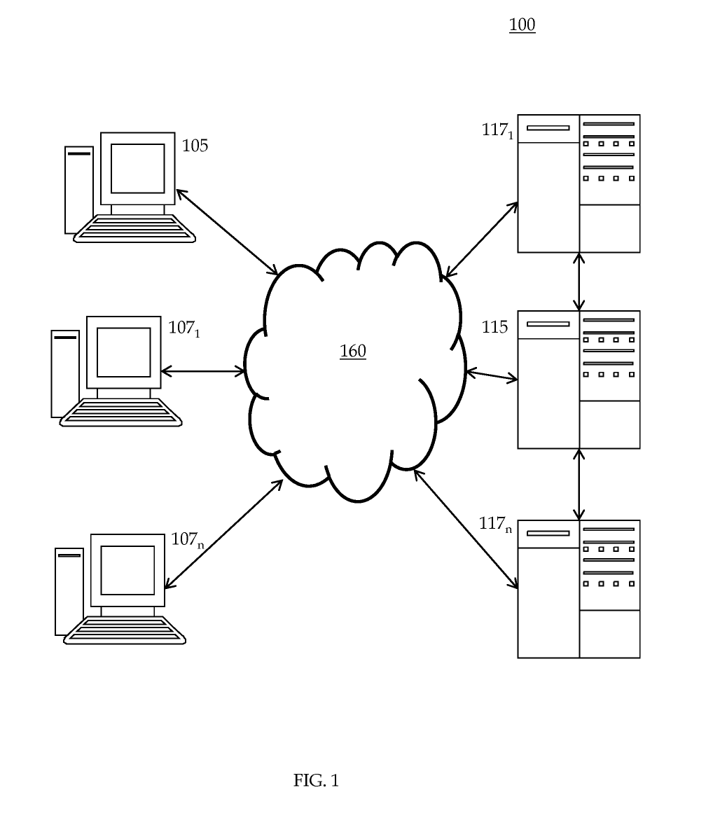

FIG. 1 depicts a system-level network diagram of an electronic mold prevention system 100 in accordance with embodiments of the present invention. In exemplary embodiments, the system 100 may be adapted to capture, transmit, analyze, filter, review, display, and/or archive all information and data relating to mold prevention and providing a detailed, easy to access, electronic account of mold risk in one or more locations. In accordance with embodiments of the present invention, information may be collected from multiple data sources and transmitted to a central repository where the data may be aggregated, filtered, and flagged for immediate review, or archived for future retrieval based on a comparison to one or more predetermined thresholds. Embodiments of the present invention may generally provide alerts and/or notifications of possible incidences of mold risk, and may lead to more accurate predictability of mold formation, providing numerous benefits to building users, mold remediation providers, property managers, property owners, and/or the like.

In accordance with exemplary embodiments, the system 100 generally comprises at least a first client 105, generally in communication with a server 115 via a network 160. In some embodiments, the system 100 may comprise secondary clients 1071 and 107n. The clients may be in communication with the host server 115, generally through the network 160.

As used herein, the terms “building users” and “building users” may refer to one or more individuals that occupy, own, reside in, manage, use, or are otherwise present in a location where mold has the potential to form. As used herein, the term “mold remediation provider” may refer to an individual, business, or institution that provides mold remediation and/or removal services to individuals, property owners, property managers, and/or the like. For example, a “mold remediation provider” may refer to an owner of a mold remediation business, an employee of a mold remediation business, a contractor for a mold remediation business, a business entity or individual affiliated with a mold remediation business, and/or the like.

As used herein, the term “property manager” may refer to an individual or institution in the field of property management. For example, a property manager may include a property owner, a property tenant, private property management companies, government property managers, other individuals or entities that provide property management, and/or the like. As used herein, the terms “mold prevention data” may refer to measures of various pieces of collected data or statistics taken in order to assess mold risk. For example, some mold prevention data may include humidity data, temperature data, location data, and/or the like. As used herein, the term “administrator” may refer to any user with administrative access to the systems and methods in accordance with embodiments of the present invention. As used herein, the term “mold remediation procedure” may refer to any method of removal and/or remediation of existing mold. For example, a mold remediation procedure may comprise containment, demolition, and/or replacement of building materials, and/or the like. In exemplary embodiments, the term “system users” may refer to any individual, group, computer, and/or the like that is provided access to the systems and methods disclosed herein, and/or the like.

A system 100 in accordance with embodiments of the present invention may be adapted to provide a proactive approach to controlling mold fungi formation by preventing it. In exemplary embodiments, a system 100 may comprise one or more remote temperature and/or humidity sensors installed inside a mold prevention area, such as a condominium, multi-unit, single family home, townhome, apartment, commercial area, and/or the like. For example, the remote temperature and/or humidity sensors may be installed in condominium units, hallways and common areas, and/or the like to capture mold prevention data. In some embodiments, mold prevention data may comprise one or more temperature and/or humidity readings from one or more locations at a predetermined time and/or over a predetermined time period. In exemplary embodiments, systems and methods in accordance with the present disclosure may be adapted to capture, measure, store, display and/or transmit relative humidity and/or temperature readings over time. If a spike occurs in temperature and/or relative humidity, an alert may be generated and transmitted to a user, or the like. In some embodiments, a graphical report may be generated displaying in temperature and/or humidity readings/calculations over time. In some embodiments, the average temperature and/or humidity readings/calculations for a location and/or group of locations, such as a section of a building, may be recorded and displayed in a graph. For example, the average temperature and/or average humidity over a predetermined time period, or in real-time, for a group of condo units, or the like, may be displayed on a graph in accordance with embodiments of the present disclosure. In some embodiments, the sensors may be adapted to collect mold prevention data and transmit the mold prevention data to a remote computer via a network, such as a wireless network, a wired network, the Internet, and/or the like.

In accordance with exemplary embodiments, when the system 100 captures and/or saves temperature and/or humidity levels inside a structure, the system 100 may be adapted to analyze the data to determine if a risk above a predetermined level exists for the formation of mold. For example, absence or non-existence of air conditioned and unconditioned spaces behind closed doors may cause the relative humidity to spike upward above a predetermined threshold, for example, above 60%. When the relative humidity spikes above a predetermined threshold, system may be adapted to indicate that conditions are created within the structure that may cause formation of mold fungi, and/or the like. In some embodiments, mold prevention data may be collected at predetermined times of the day or on predetermined days, or may be collected and/or analyzed in real-time or substantially in real-time.

In accordance with exemplary embodiments, if the system 100 analyzes the data and determines that a condition exists that may lead to mold formation, such as an increase in relative humidity above a predetermined threshold, the system 100 and/or the sensor may be adapted to alert one or more system users. An alert may indicate to one or more system users that the potential for mold formation exists, and that temperature and/or humidity conditions should be adjusted to prevent the formation of mold. In some embodiments, an alert may provide an indication that an inspection should be settled, and the system 100 may be adapted to schedule a mold inspection and/or coordinate the scheduling of an inspection with the property owner, the property manager, the tenant, the mold remediation provider, any system user/and or the like.

A system 100 in accordance with exemplary embodiments, may assist system users in maintaining health levels of indoor air quality and prevent the need for disruptive, costly, and environmentally-unfriendly mold remediation. A system 100 in accordance with exemplary embodiments may be adapted to tabulate monthly usage time, a number of alert occurrences, a number of inspections scheduled, and/or the like and may calculate a monthly or periodic usage rate of the system 100 for a particular system user. For example a user may be charged by the time period monitored, per each alert occurrence, per each inspection, and/or the like. Installing a system 100 in accordance with exemplary embodiments may also be adapted to provide the identification of a potential fire inside the structure by monitoring temperature increases. When a predetermined level of temperature increase occurs, an alert may be generated by the system 100 and may alert a system user to a potential fire before smoke detection, thereby providing potential life-saving and property-saving benefits.

A system 100 in accordance with embodiments of the present invention may provide various benefits to system users, and/or the like. System users may be provided with access to a summary any mold prevention data and/or analysis data collected in a location, multiple locations, or multiple groupings of locations, and/or the like. In accordance with exemplary embodiments, the system 100 may be adapted to provide the system users with a mold risk assessment, that may include a complete temperature and humidity record retrieved from a mold prevention area, a record of any abnormal changes in temperature and/or humidity occurring during the data collection, and/or the like. As such, the system 100 may be adapted to provide historical data regarding a mold prevention area by keeping complete and accurate records of mold prevention data collection and/or analysis data.

In exemplary embodiments, if a system 100 for mold prevention is utilized, the costs for mold remediation may generally decrease because the system users may be identified of temperature and/or humidity conditions that may cause a high likelihood of mold formation, thereby allowing the user to substantially prevent mold formation and/or growth by adjusting the temperature and/or humidity in the mold prevention area. In some embodiments, when the system 100 detects conditions in temperature and humidity that may lead to the formation and/or growth of mold, the system may be adapted to automatically adjust the temperature and/or humidity settings in a mold area. For example, if the temperature and/or humidity surpass a certain threshold, the system may be adapted to automatically adjust raise an air conditioning/cooling output and/or activate a dehumidifier, and/or the like.

By way of example, some seasonal residents of higher temperature areas may leave their property for a portion of the year. When these residents leave their property, they may shut off the air conditioning in high temperature conditions. In an unconditioned space, relative humidity may spike such that mold rapidly forms. These conditions may be true of an individual unit, a group of units, or a building in general. The system 100 may be adapted to analyze the relative humidity data and identify areas, such as an individual unit, a group of units, or a building in general is at a high risk for mold formation. The system 100 may alert one or more system users as to the presence of conditions that may result in mold formation. In some embodiments, the system 100 may be adapted to take measures, such as turning the air conditioning on in an individual unit, a group of units, or an entire building when an alert has been generated, or unfavorable conditions have been detected, and/or the like. In some embodiments, the mold prevention data, such as temperature, humidity, relative humidity and/or the like in an individual unit may be compared to neighboring units and/or outside and an alert may be generated if the unit has higher temperature and/or humidity reading above a predetermined threshold when compared to the neighboring units and/or outside.

In addition to reducing mold remediation costs for system users, mold remediation providers may also benefit from a system 100 in accordance with the present invention. Mold remediation providers may benefit by receiving a complete record of mold prevention data collection and/or analysis in an easy to access electronic file, thereby providing the mold remediation providers with an accurate assessment of where mold is likely to exist in a building or the like. By utilizing a system 100 in accordance with embodiments of the present invention, mold remediation providers may improve their ratings and reputation by alerting prospective system users that conditions exist that may cause formation and or growth of mold fungi, and/or the like.

A system 100 in accordance with the present invention may also provide benefits to property managers and property owners. A system 100 in accordance with the present invention may be adapted to provide property managers and property owners with a complete record of all mold prevention data collection and/or analysis data in an easy to access electronic file. These complete records may indicate to the property manager and property owner that they should notify a tenant, resident, and/or the like that a mold remediation and/or prevention procedure should be undertaken in a location, or that a history of unfavorable conditions have been present in a location.

A system 100 in accordance with embodiments of the present invention may also provide system users with an alert and/or warning that a mold risk conditions are present, encouraging pro-active prevention and/or remediation procedures. As such, a system 100 in accordance with embodiments of the present invention may result in the ability to reduce costs and/or receive more competitive property insurance and or other liability insurance coverage/rates to system users. A system 100 in accordance with embodiments of the present invention may also reduce mold injury claims, thereby reducing insurance coverage rates, premiums, and/or the like.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary clients 1071 and 107n, it should be appreciated that “n” represents any number of clients feasible in accordance with embodiments of the present disclosure. For ease of reference, as used herein, the term “client” may refer to any one or all of the clients, 105, 1071, and 107n within the system 100. A “client” may refer to a system user and/or computer utilized by a system user. In certain embodiments, multiple clients may perform the same or similar functions. For ease, one client 105 will be referred to herein, however in exemplary embodiments, more than one client 105 may be included in the system 100.

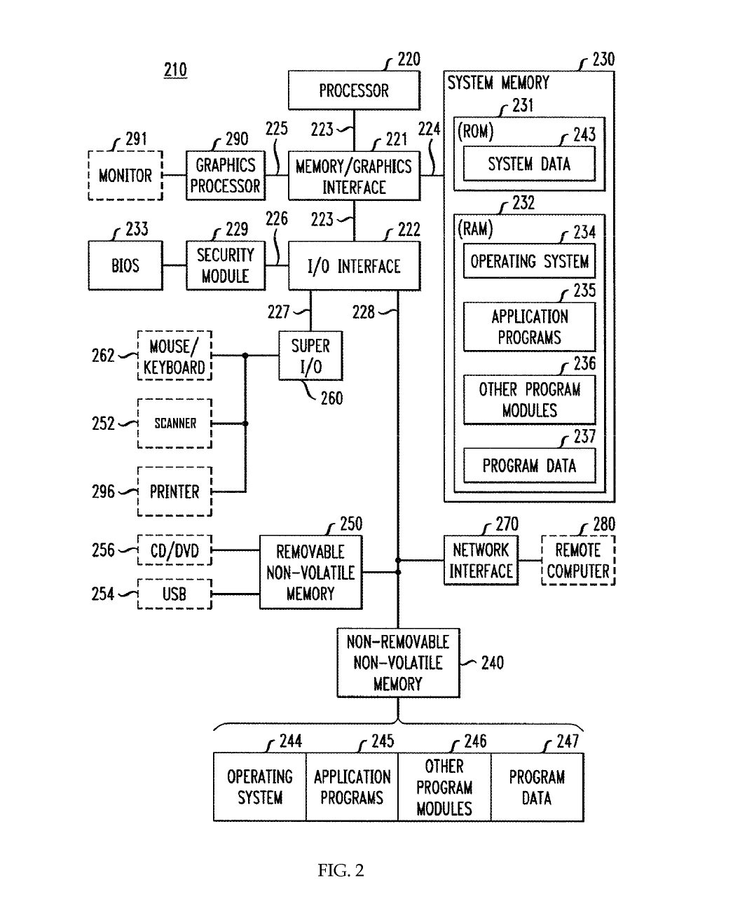

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

FIG. 2 depicts a block diagram of a general computer system, which is capable of being used in connection with the system depicted in FIG. 1, in accordance with embodiments of the present disclosure. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), blue-ray or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any security technology suitable for embodiments disclosed herein.

A super input/output chip 260 may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital temperature tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure.

It is understood by embodiments of the present disclosure that a computer, such as the one depicted in FIG. 2, may be connected to a computer network or system. A computer network may include the Internet, a global computer network, an internal computer network, dedicated server networks, or the like.

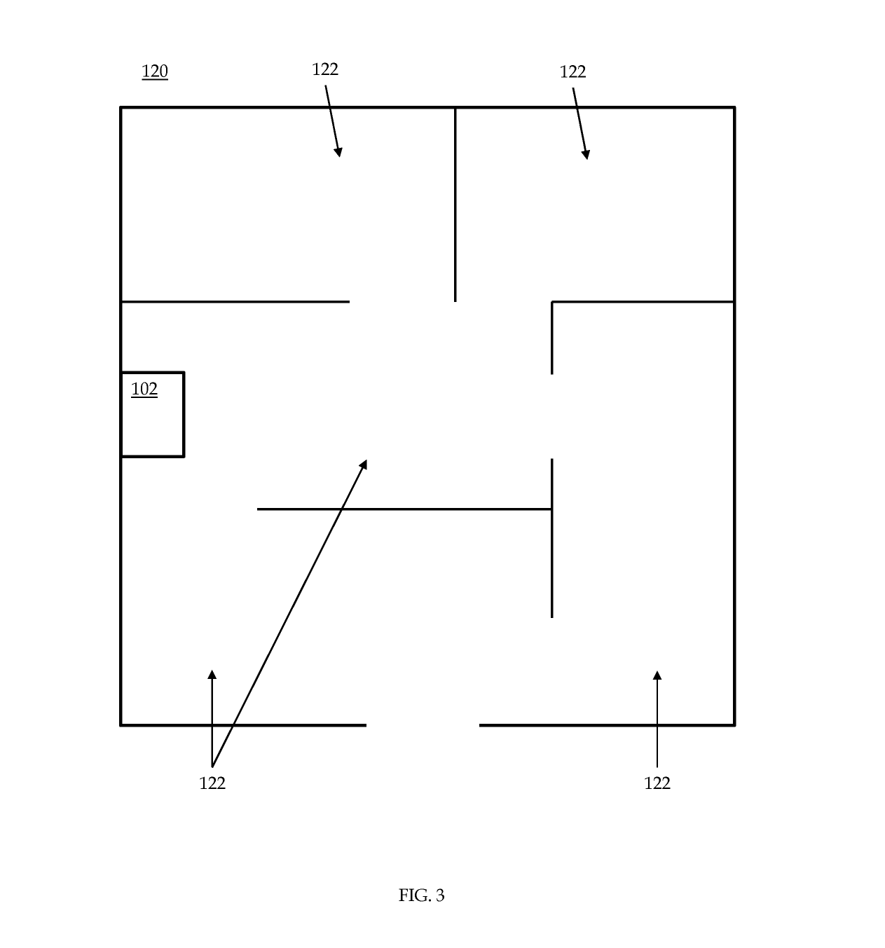

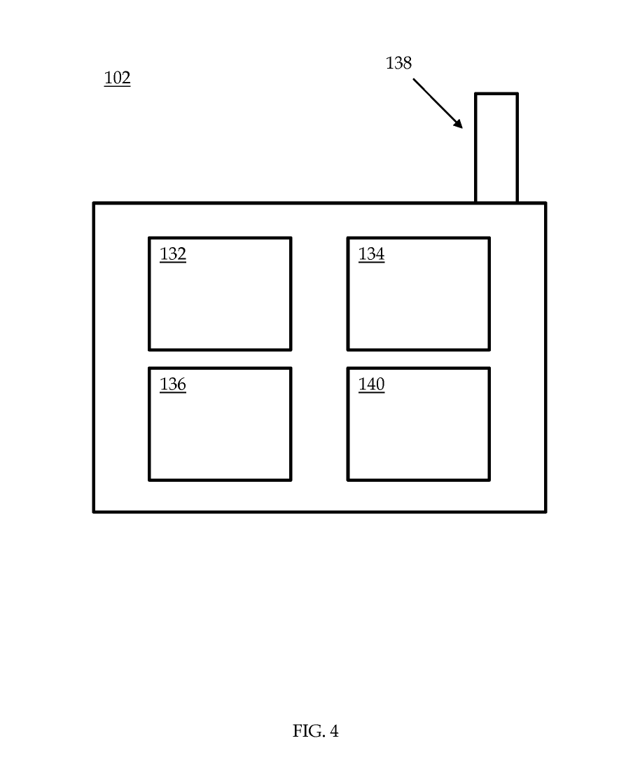

FIG. 3 depicts a top view of a location 120 and a monitor 102 in accordance with embodiments of the present invention. In exemplary embodiments, a location 120 may comprise any structure or area to be monitored. The location 120 may comprise an area in which monitoring for conditions that cause a high risk of mold formation is desired. For example, a location 120 may comprise a commercial office, a residential dwelling, a government office, a recreational building, and/or the like. In some embodiments a location 120 may comprise one or more sub-locations 122, such as rooms, or the like. In some embodiments, one or more monitors 102 may be installed in the location 120. Although one monitor 102 is depicted in FIG. 3, additional monitors are contemplated by and within embodiments of the present disclosure. In some embodiments, a monitor 102 may be installed in one or more sub-locations 122 with a known higher risk of mold formation, such as a basement, an attic, a bathroom, and/or the like. In some embodiments, the monitor 102 may be adapted to indicate to the system a type of room the monitor is disposed in. For example, if the monitor 102 is disposed in a bathroom, the system may be adapted to ignore spikes in relative humidity for short or predetermined periods of time that may be caused by use of the bathroom shower, and/or the like. The system may be adapted to generally ignore such spikes over short periods of time, and/or the like. The monitor 102 may also be installed in the location of a room that may produce more accurate results, such as the center of a room and/or near an area where mold risk is high. A monitor 102 may be attached to a wall, integral with a wall, coupled with an electrical outlet, attached to a ceiling, attached to a floor, or may operate as detached unit within the location 120 that may be moved according to the needs of one or more system users. For example, if mold is detected in an area, the monitor 102 may be moved to that area. An exemplary monitor 102 is depicted in FIG. 4.

FIG. 4 depicts a block diagram of a monitor 102 in accordance with embodiments of the present invention. In exemplary embodiments, a monitor 102 may be adapted to detect, collect, analyze, transmit, and/or store data related to an increased risk of mold formation. A monitor 102 may be adapted to capture temperature data, humidity data, air content data, and/or the like. A monitor 102 may generally comprise a sensor 132, a power source 134, an alarm 136, a communications member 138, and/or an electronic mold prevention system 140. In exemplary embodiments, a monitor 102 may comprise a temperature and/or humidity sensor 132 onboard that may be replaceable. A monitor 102 may be mountable to a wall, and/or the like. A monitor 102 may collect data with the sensor 132, the data comprising at least one of temperature and humidity data. The sensor 132 may be calibrated to a standard, and may be coupled with a chip adapted to calibrate the sensor 132. The sensor 132 may comprise a medical grade temperature and humidity sensor and/or the like.

In exemplary embodiments, a monitor 102 may be adapted to relay, transmit, and/or receive data to/from a server. The data may be stored onboard in the monitor 102 or on a remote server. The power source 134 may comprise any power source consistent with the present invention such as AC/DC electrical power, power received via a plug and an electrical outlet, power received from a battery, solar power received from an outdoor unit, and/or the like. The power source 134 may comprise a combination of power sources and/or a main power source and a backup power source. The power source 134 may comprise a battery that may last between 1-8 years, and/or the like. In some embodiments, the alarm 136 may be adapted to alert a system user that temperature and/or humidity conditions exist that are likely to lead to mold formation. In some embodiments, the alarm may comprise an audio output and/or a visual output. For example, the audio output may be adapted to provide a buzzer, a bell, a beeping noise, a recorded or simulated voice instructing the user to adjust temperature and/or humidity levels, and/or the like, and the visual output may comprise a light, a display for displaying text, video, and/or images, and/or the like.

The communications member 138 may be adapted to transmit and/or receive data to a remote server, a control unit, and/or an additional monitor (not shown). In some embodiments, the communications member 138 may comprise a wireless antenna. The communications member 138 may be adapted to transmit and/or receive in numerous frequencies and signal powers, thereby eliminating interference with existing networks. For example, the communications member 138 may be adapted to transmit and/or receive in 900 MHz, 932 Mhz, 1.2 GHz, 148 MHz, and/or 433 MHz. In some embodiments, the communications member The communications member 138 may be adapted to transmit and/or receive a wired and/or wireless data signal. For example, the communications member 138 may be adapted to communicate with a Wi-Fi network. In some embodiments, the monitor 102 may be adapted to transmit an unobstructed signal in an area between one and four miles, and/or the like. The monitor 102 may comprise a memory adapted to store at least a portion of a mold prevention system 140.

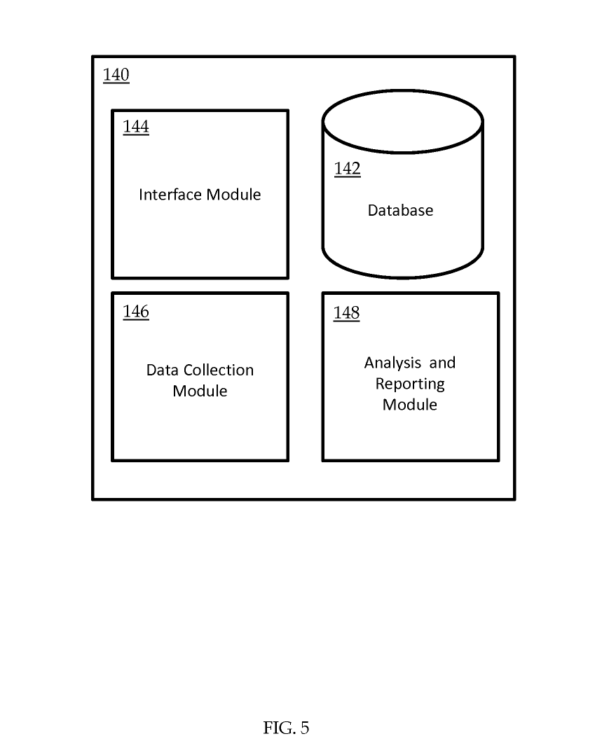

FIG. 5 depicts a block diagram of an electronic mold prevention system 140 in accordance with embodiments of the present invention. The mold prevention system 140 may generally comprise computer executable software and/or instructions configured to perform the functionality of the systems and methods disclosed herein. The mold prevention system 140 may be stored on a server, on a local computing device, on a mobile communications device, on a monitor, and/or the like. The mold prevention system 140 may comprise a database 142, an interface module 144, a data collection module 146, an analysis and reporting module 148, and/or the like. In accordance with exemplary embodiments of the present invention, any module may be merged and/or combined with any other module. In some embodiments, additional or fewer modules than those depicted in FIG. 5 may be included.

In exemplary embodiments, the mold prevention system 140 may be configured to capture, analyze, and store all data relating mold prevention. The mold prevention system 140 may be adapted to collect mold prevention data via one or more data sources, such a monitor. The system 140 may be adapted to receive the mold prevention data from the one or more sources, analyze mold prevention data, generate an alert if the mold prevention data meets a predetermined condition, store at least a portion of the mold prevention data, present a report to a user, and/or schedule a mold inspection. In some embodiments, the mold prevention system 140 may be configured to provide real-time or substantially real-time mold prevention data to users upon request, at predetermined intervals, upon the occurrence of an event, and/or the like.

In exemplary embodiments, the interface module 144 may be adapted to provide the user with a means for interacting with the mold prevention system 140. The interface module 144 may be adapted to present a graphical user interface (GUI) to the user, the GUI adapted to allow users to input, view, and interact with the mold prevention system 140. In some embodiments, the interface module 144 may be adapted to present mold prevention data to a user via a display on a computer, a tablet, a mobile device, a laptop, a touchscreen device, and/or the like. The interface module 144 may also be adapted to provide an opportunity to register a user account for accessing the mold prevention system 140. User accounts may be restricted to authorized personnel and a verification of a user's identity may be required. In some embodiments, user account requests must be approved by an administrator of the mold prevention system 140 and/or may only be created by an administrator. The interface module 144 may be adapted to allow a user to run a search query on data stored in the database 142.

In accordance with exemplary embodiments of the present invention, the interface module 144 may also allow a user to access mold prevention data generated, filtered, and/or stored by the analysis and reporting module 148. The interface module 144 may be adapted to allow the user to run a report on the data contained in the database 142 with the analysis and reporting module 148 upon request, at predetermined intervals, or upon the occurrence of an event. For example, a user may access mold prevention data for a particular room, location, unit, group of unit, building, group of buildings, group of buildings in a defined geographic area, locations with previous mold problems, locations with multiple incidents of mold occurrence, and/or the like upon running a report request with the interface module 144. The interface module 144 may also be adapted to transmit and/or display alert messages to the user when an event occurs, such as the relative humidity measured surpassing a predetermined threshold, and/or an alert is received from the analysis and reporting module 148. An event that triggers an alert may comprise, for example, data that indicates a likelihood of a mold formation risk, a notification that a mold inspection is completed, and/or the like.

In exemplary embodiments, alerts may be presented to the user via a display on a computer or electronic device, via a text or SMS message, via an automated phone call, via email, via an auto-generated letter via postal mail. When an alert is generated, it may be sent to multiple parties. For example, if the analysis and reporting module 148 determines that an event or exception has occurred and an alert should be generated, an alert may be generated and sent via one or more communication means to the mold remediation provider, the property manager, a property owner, a property manager's employee, a system user, an individual or company designated by a system user, and/or the like. The interface module 144 may also be customized by a user and/or an administrator. For example, the interface module 144 may be customized to display mold prevention data in a customized visual format displaying certain locations and/or data, at certain time intervals, upon the occurrence of an event, or upon request of a user and/or administrator.

In accordance with exemplary embodiments of the present invention, the data collection module 146 may be adapted to receive data from a device, such as a monitor consistent with the present disclosure. In exemplary embodiments, mold prevention data may comprise real-time monitoring data, data collected at a predetermined time, historical data, and/or the like. For example, data in a mold prevention record may comprise a historical mold detection data, historical temperatures, historical humidity measurements, a current temperature measurement, a current humidity measurement, and/or the like.

In some embodiments, the temperature data may be temperature recorded by one or more temperature sensors disposed in a mold prevention area. The temperature sensors may collect temperature in an area over a predetermined time or in real-time. In some embodiments, one or more temperature sensors and/or humidity sensors may be distributed throughout a mold prevention location and may transmit collection data to a central control unit, for example, the monitor described with respect to FIG. 4. The monitor may be adapted to collect data from one temperature and/or humidity sensor, and or multiple sensors at various locations throughout a mold prevention area, such as a residence or commercial space.

In some embodiments, the humidity data may be humidity recorded by one or more humidity sensors disposed in a mold prevention area. The humidity sensors may collect humidity measurements in an area over a predetermined time or in real-time. In some embodiments, one or more humidity sensors may be distributed throughout a mold prevention location and may transmit collection data to a central control unit, for example, the monitor described with respect to FIG. 4. The monitor may be adapted to collect data from one humidity and/or humidity sensor, and or multiple sensors at various locations throughout a mold prevention area, such as a residence or commercial space.

In some embodiments, mold prevention data, which may comprise temperature data and/or humidity data, is forwarded to the analysis and reporting module 148 and/or saved in a database 142. In accordance with exemplary embodiments, a database 142 may be adapted to store all mold prevention data in accordance with the present invention. In accordance with exemplary embodiments, the analysis and reporting module 148 may be adapted to analyze mold prevention data collected by the data collection module. The analysis and reporting module 148 may be adapted to apply one or more sets of rules against data collected by the data collection module 146. The analysis and reporting module 148 may be adapted to find and/or identify data that indicates a high likelihood of mold formation in an area.

The analysis and reporting module 148 may be adapted to flag and identify potential mold formation risks and present the risk(s) to a user and/or administrator via an alert, a report, or upon request from the user and/or administrator. The analysis and reporting module 148 may compare the collected mold prevention data a range of acceptable mold prevention data comprising ideal temperatures and/or humidity. Acceptable mold prevention data may comprise a temperature, humidity measurement, range of temperatures, a range of humidity measurements, and/or a combination thereof that indicate a low risk of mold formation. If the collected mold prevention data does not match and/or fall within the acceptable mold prevention data, an indication that the risk of mold formation is high may be generated and/or sent. When an alert that a high risk of mold formation exists in a location, the analysis and reporting module 148 may be adapted to notify a user and/or administrator via the interface module 144. The analysis and reporting module 148 may also be adapted to generate reports and/or alerts comprising a summary of data collected from all locations, including mold prevention data collected from a specific room, a specific area of a room, a specific location, a specific unit, a group of units, a group of rooms, a building, a group of buildings, real-time data, historical data, and/or the like. The system 140 may be adapted to display in one coherent display data collected from a selected group of locations, historical data from a selected location, all locations managed by a user, all locations where the system has indicated a high risk of mold formation is present, all locations where the system has indicated a low risk of mold formation is present, all locations that the system has indicated possesses a history of repeated detection of data indicating a high risk of mold formation, all locations that have had a predetermined and/or selected number of incidents wherein the system has indicated a high risk of mold formation exists, and/or the like. In some embodiments, the system may be adapted to generate and display trends in the data, that my include charts and alerts, that may be transmitted and/or presented to any user of the system, including a service technician, a property manager, and/or the like. The reports and/or alerts may be transmitted and/or displayed to the user via text or SMS message, mobile communication device, email, postal mail, television, audible alert, visual alert, social media message, a report generated on the display of a computing device, and/or the like. In exemplary embodiments each of the data collection devices, such as the monitors, may be adapted to collect data and/or transmit data to the analysis and reporting module 148 or any module in accordance with the present invention.

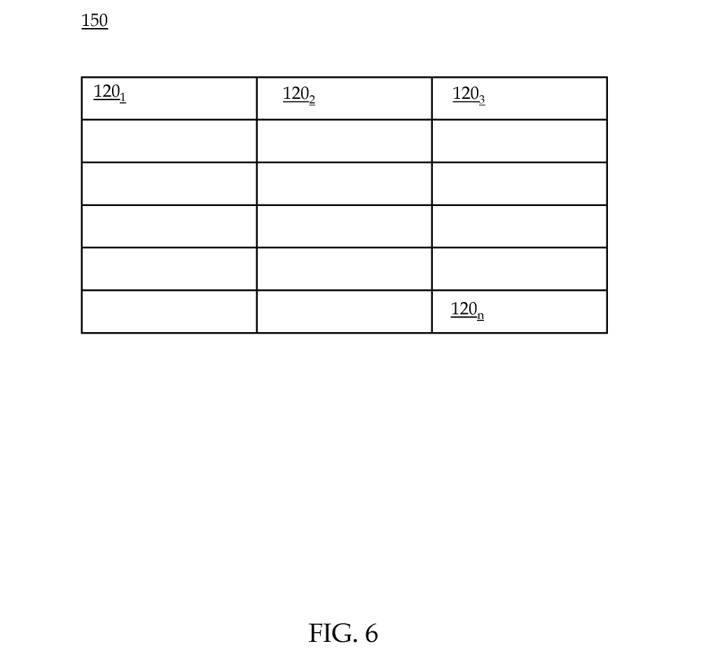

FIG. 6 depicts a block diagram of a side view of an exemplary building 150 in accordance with embodiments of the present invention. A building 150 may generally comprise at least one location 120 for which mold prevention is desired. Although FIG. 6 references four secondary clients 120₁, 120₂, 120₃, and 120ₙ, it should be appreciated that “n” represents any number of locations feasible in accordance with embodiments of the present disclosure. For ease of reference, as used herein, the term “location 120” may refer to any one or all of the locations, 120₁, 120₂, 120₃, and 120ₙ within the system. In some embodiments, each location 120 may be situated in a building 150. One or more of the locations 120 may comprise components of exemplary systems of the present invention. For example, a monitor in accordance with exemplary embodiments, such as the monitor described with reference to FIG. 4, may be installed in each location 120 or a selected group of locations 120. In some embodiments, a monitor may be installed only in locations wherein mold has been previously found. In some embodiments, the monitors installed in one or more locations 120 may be adapted to communicate to one or more remote servers. In some embodiments, the remote server may be disposed at a remote location. In some embodiments, the remote server may be disposed in one or more locations 120.

A monitor may be coupled with one or more temperature and/or humidity sensors that maybe disposed on the monitor or disbursed throughout the locations. The system may be adapted to indicate what portion of each location 120, what location 120, the date, time, exterior temperature and weather conditions, what group of locations 120 and/or the like have collected data that indicates a higher likelihood of mold formation, based upon data analysis and comparison with ideal temperature and/or humidity levels. In some embodiments, multiple buildings may be monitored. In some embodiments, the analysis may be presented to a system user starting with a listing of buildings that include a higher risk of mold formation, and allow the user to drill down using a selectable menu on an interface, to more detailed levels, such as specific locations, specific areas within locations, specific dates, specific times, and/or the like. In some embodiments the system may perform an analysis of locations 120 within a building and may generate an alert if adjoining locations, adjacent locations, locations in the same building, locations on the same floor, locations in the same room, and/or the like and generate an alert or the like if a pattern of similarly situated locations exists. For example, the system may indicate if a particular area of a building 150 has experienced a spike in temperature and/or humidity, possibly due to loss of power. In some embodiments, the system may be adapted to compare similarly situated and/or located locations 120 and determine if a recorded temperature and/or humidity measurement in one location is higher than that of the similarly situated and/or located location, and if so, the system may generate an alert in accordance with embodiments of the present invention.

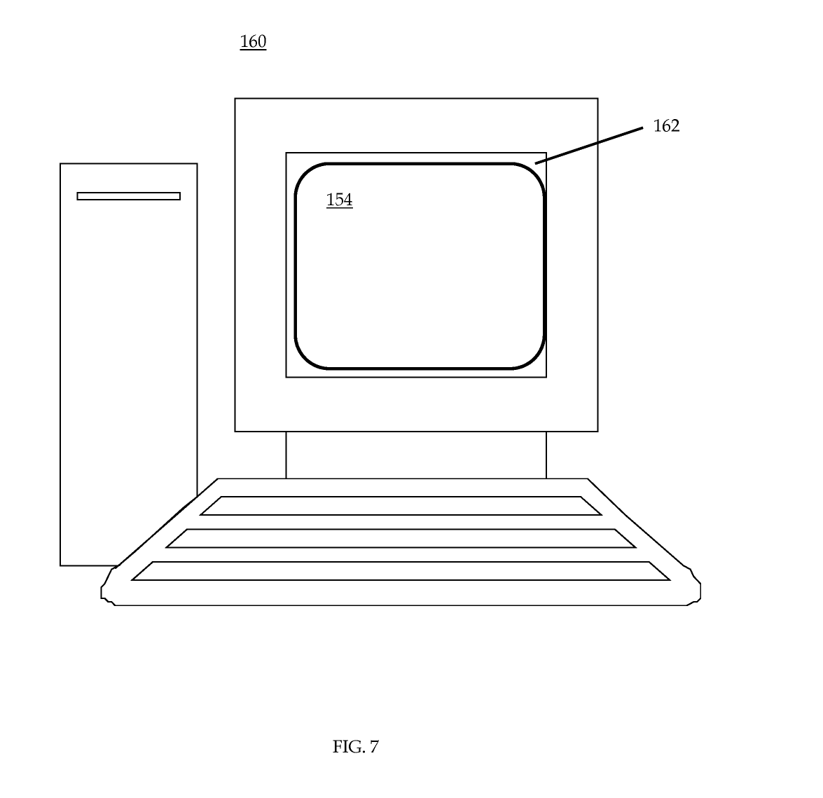

FIG. 7 depicts an exemplary client 160 capable of being used with the system depicted in FIG. 1, in accordance with embodiments of the present disclosure. In exemplary embodiments, the client computer 160 may comprise a display 162. The display 162 may be adapted to display at least an interface 154. In exemplary embodiments, the functionality and appearance of the display may be determined by an interface module. The interface 154 may be adapted to display any data and analysis collected, stored, and/or analyzed by a system in accordance with embodiments of the present invention. Although a client computer 160 is depicted as a personal computer in FIG. 5, any computing device may be used. By way of example, a mobile phone, a tablet computer, a laptop computer, and/or the like may be used, to name a few.

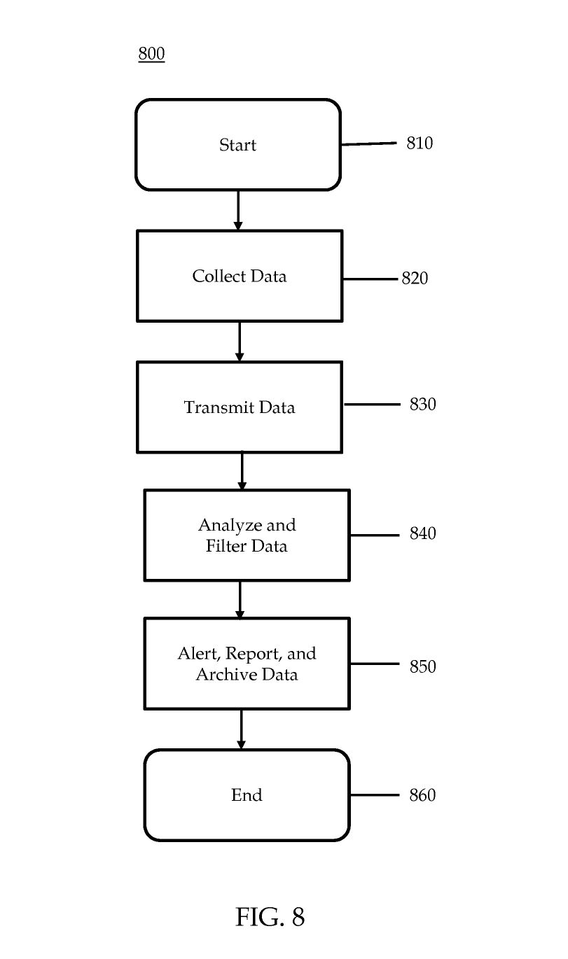

FIG. 8 depicts a flow diagram illustrating an exemplary method for electronic mold prevention in accordance with embodiments of the present invention. In exemplary embodiments, the computer-implemented method 800 may comprise collecting, transmitting, analyzing, filtering, reporting, and/or archiving mold prevention data. The method 800 may be carried out using the architecture and components described in the systems above, or may utilize any other type of system architecture suitable for embodiments of the present invention. It should further be appreciated, the steps of method 800 may be carried out in any order (e.g., step 830 may occur before step 820), unless otherwise explicitly specified by the steps of the exemplary method. For ease, exemplary methods represented in FIG. 8 are described with reference to the client 105, server 115, and mold prevention system 140 described above. The method 800 may be carried out using other embodiments as well. Many steps of the method 800 may generally be carried out by the mold prevention system 140. The mold prevention system 140 may be stored on a client 105, a server 115, or any other data storage location consistent with the present disclosure. It will be appreciated that the steps of the method 800 may be performed exclusively on the client 105 or partially on the client 105 and partially on the server 115. Any combination of shared computing power for performing the steps of the methods described herein consistent with the present disclosure is contemplated. For example, multiple clients 105 and servers 115 may collaborate to perform the steps of method 800.

The method 800 begins at step 810. At step 820, mold prevention data is collected via a monitor in accordance with embodiments of the present invention. At step 830, after the data is collected, the data may be transmitted to and received by the data collection module. The data collection module may coordinate, receive, and sort all data received from the monitor. The data collection module may transmit the collected data to an analysis and reporting module.

At step 840, data is received by the analysis and reporting module for analysis. In accordance with exemplary embodiments, the received data is compared against parameters indicating acceptable ranges of temperatures and/or humidity measurements for mold prevention. If a condition is met that identifies a potential risk of mold formation, a mold risk alert, or the like, may be generated.

At step 850, if the system 140 determines a condition exists that may result in the formation of mold, mold risk alert may be generated and transmitted to a system user. The mold risk alert, or the like, may be printed in a report, displayed on a computer screen via an interface, or the like, transmitted via email, transmitted via text message, and/or stored in a database in accordance with embodiments of the present invention.

A separate report may also be generating displaying all mold prevention data for a particular location, room, unit, group of units, building, and/or group of buildings in a dashboard and/or coherent display. In accordance with exemplary embodiments, the data may be archived and saved in a database, or the like, for later retrieval. After all alerts, if any, have been generated by the system and transmitted to appropriate system users, individuals, groups, and/or companies, the method 800 ends at step 860.

While the foregoing is directed to embodiments of the present disclosure, other and further embodiments of the disclosure may be devised without departing from the basic scope thereof. It is also understood that various embodiments described herein may be utilized in combination with any other embodiment described, without departing from the scope contained herein. In addition, embodiments of the present disclosure are further scalable to allow for additional clients and servers, as particular applications may require.

What is claimed is:

1. A computer-implemented method for mold prevention, the method comprising:
at a server having one or more processors and memory storing one or more programs for execution by the one or more processors:
receiving mold prevention data from a monitor disposed in a first location;
analyzing the mold prevention data and determining if the mold prevention data conforms to an acceptable range of values;
generating an alert or alerts if the mold prevention data does not conform to the acceptable range of values and prior to breach of acceptable ranges; and
storing the mold prevention data in a database.

2. The method of claim 1, wherein the mold prevention data comprises at least one of relative humidity data and temperature data.

3. The method of claim 1, wherein the monitor is adapted to calculate relative humidity, measure temperature, and capture time.

4. The method of claim 1, further comprising:
receiving a second set of mold prevention data from a second monitor disposed in a second location;
analyzing the second set of mold prevention data and determining if the second set of mold prevention data conforms to the acceptable range of values;
generating an second alert if the second set of mold prevention data does not conform to the acceptable range of values; and
storing the second set of mold prevention data in a database.

5. The method of claim 4, further comprising:
displaying, with the computer, a summary of a set of locations managed by an administrator.

6. The method of claim 5, wherein the summary comprises an indication of the first alert and the second alert.

7. The method of claim 1, wherein the monitor comprises:
a sensor adapted to collect measurements of least one of temperature and humidity;
a power source;
an alarm; and
a communications member.

8. The method of claim 7, wherein the power source comprises at least one of an electrical cable and a battery.

9. The method of claim 7, wherein the alarm is adapted to provide at least one of an audible or visual alarm if an alert is generated.

10. The method of claim 7, wherein the communications member is adapted to wirelessly transmit and receive mold prevention data to the server.

11. The method of claim 1, further comprising transmitting the alert to a system user via at least one of an email and a text message.

12. A computer-implemented method for mold prevention, the method comprising:
at a client having one or more processors and memory storing one or more programs for execution by the one or more processors:
receiving mold prevention data from a monitor disposed in a first location;
analyzing the mold prevention data and determining if the mold prevention data conforms to an acceptable range of values;
generating an alert if the mold prevention data does not conform to the acceptable range of values;
storing the mold prevention data in a database;
receiving a second set of mold prevention data from a second monitor disposed in a second location;
analyzing the second set of mold prevention data and determining if the second set of mold prevention data conforms to the acceptable range of values;
generating an second alert if the second set of mold prevention data does not conform to the acceptable range of values; and
storing the second set of mold prevention data in a database.

13. The method of claim 12, wherein the mold prevention data comprises at least one of relative humidity data and temperature data.

14. The method of claim 12, wherein the monitor is adapted to calculate relative humidity.

15. The method of claim 12, wherein each of the monitors comprise:
a sensor adapted to collect measurements of least one of temperature and humidity;
a power source;
an alarm; and
a communications member.

16. The method of claim 15, wherein the power source comprises at least one of an electrical cable and a battery.

17. The method of claim 15, wherein the alarm is adapted to provide at least one of an audible or visual alarm if an alert is generated.

18. The method of claim 15, wherein the communications member is adapted to wirelessly transmit and receive mold prevention data to the server.

19. A system comprising at least one server, the server comprising:
one or more processors; and
memory;
wherein the at least one server is configured to:
receive mold prevention data from a monitor disposed in a first location;
analyze the mold prevention data and determining if the mold prevention data conforms to an acceptable range of values;
generate an alert if the mold prevention data does not conform to the acceptable range of values; and
store the mold prevention data in a database.

20. The system of claim 19, wherein the monitor comprises:
a sensor adapted to collect measurements of least one of temperature and humidity;
a power source;
an alarm; and
a communications member.
